(19) United States
(12) Patent Application Publication
(10) Pub. No.: US 2025/0257477 A1
(43) Pub. Date: Aug. 14, 2025

(54) METHOD OF ELECTROLYSING HYDROGEN BROMIDE AFTER H2SO4 SYNTHESIS

(71) Applicant: TOTALENERGIES ONETECH, Courbevoie (FR)

(72) Inventors: Miroslav KETTNER, Seneffe (BE); Gleb VERYASOV, Seneffe (BE); Thomas TUREK, Clausthal-Zellerfeld (DE); Ulrich KUNZ, Clausthal-Zellerfeld (DE); Heiner GRIMM, Clausthal-Zellerfeld (DE)

(21) Appl. No.: 18/998,221

(22) PCT Filed: Jul. 24, 2023
(86) PCT No.: PCT/EP2023/070471

§ 371 Date: Jan. 24, 2025

(30) Foreign Application Priority Data
Jul. 25, 2022 (EP) 22315171.3
Jul. 25, 2022 (EP) 22315172.1

(51) Int. Cl. C25B 1/50; C25B 1/04; C25B 9/05; C25B 9/23; C25B 13/08; C25B 15/021

(52) U.S. Cl. CPC C25B 1/50; C25B 1/04; C25B 1/24; C25B 9/05; C25B 9/23; C25B 13/08; C25B 15/021

(57) ABSTRACT

A method of electrolysing hydrogen bromide comprising the steps i) synthesizing sulfuric acid such that hydrogen bromide is produced, ii) providing an electrolytic cell comprising an anode, a cathode, and a membrane sandwiched between the anode and the cathode, iii) feeding a first composition comprising hydrogen bromide and water to the anode, iv) feeding a second composition comprising hydrogen bromide and water to the cathode, and v) operating the electrolytic cell to produce hydrogen at the cathode.

### TECHNICAL FIELD

The disclosure relates to methods of electrolysing hydrogen bromide, to gases obtained by such methods and corresponding uses.

### TECHNICAL BACKGROUND

The global demand for hydrogen (H₂) and H₂-derived fuels will significantly increase in the coming years. This is inter alia because H₂ is expected to play a key role in mitigating global warming. In order to produce H₂ in an eco-friendly manner, water electrolysis using renewable electricity is nowadays a standard technology, and the hydrogen produced thereby is also called green hydrogen. There are basically three technologies to accomplish water electrolysis, namely alkaline electrolysis (AEL), proton exchange membrane electrolysis (PEMEL), and solid oxide electrolysis (SOEL).

The different technologies have different operation ranges and different efficiencies. SOEL technology is for example a high-temperature solution that typically offers comparably high efficiencies. However, SOEL solutions typically have a rather limited lifetime and require relatively high capital expenditures (CAPEX) in combination with generally lower technology readiness levels. AEL is the oldest technology but is less flexible than PEMEL and does not allow for regulation of power over a comparably broad range. Further, AEL solutions regularly suffer from disadvantageously low current densities, which in turn increase the CAPEX. In contrast, PEMEL solutions can typically be operated at higher current densities, which brings reductions in CAPEX. As a result, PEMEL is generally favoured for water electrolysis to produce green hydrogen.

However, liquid-phase water electrolysis typically requires a rather high threshold voltage and requires comparably high energy amounts to electrolyze the water so as to produce H₂. More specifically, water electrolysis following the reaction 2H₂O→O₂+2H₂ has a threshold voltage of 1.23 V. Alternative electrolysis routes to H₂ have thus been considered. For example, electrolysis of hydrogen halogenides could provide an alternative. Of the conceivable electrolyses, electrolysis of HBr (or HBr electrolysis) occurs rarely and is much less common compared to electrolysis of either hydrogen chloride (HCl) or hydrogen fluoride (HF). On an industrial level, the only relevant practical application of HBr electrolysis is in flow batteries with the objective to store energy. Such flow batteries do however produce neither H₂ nor bromine (Br₂) for subsequent use thereof, but these compounds are rather used as energy carriers and are often even conserved in an impurified form which is sufficient for storage but is regularly not sufficiently pure for subsequent use of the H₂. Further, in flow batteries, the electrolysis is regularly performed under mild conditions in the liquid phase to avoid pressure increase and/or damage of the membrane and often runs at a limited conversion level to avoid the formation of several phases and any inhomogeneity in the system.

An HBr electrolysis under more severe conditions is described in U.S. Pat. No. 10,472,721 B1, but only in the context of the bromination of hydrogen sulfide. Furthermore, concentrated HBr compositions are only considered as a feed for an anode of an electrolytic cell, but not for a cathode thereof. Moreover, the described HBr electrolysis occurs in a biowaste treatment and recovery system to which regularly additional bromine needs to be fed, thereby increasing the operational costs of the system. Additionally, the described system regularly produces ashes as well as the greenhouse gas carbon dioxide (CO₂). The ashes need to be removed, and the CO₂ needs to be captured or converted into urea to avoid emission thereof to the environment, leading to additional operational costs for the system.

Overall, there remains a general desire for an improved method of electrolysing hydrogen bromide.

It is an object of the present disclosure to provide a method of electrolysing hydrogen bromide which at least partially overcomes the drawbacks encountered in the art. It is further an object of the present disclosure to provide a means for valorising HBr which is produced as a side product. It is also an object of the present disclosure to provide a method of electrolysing hydrogen bromide which makes HBr electrolysis more economical. It is furthermore an object of the present disclosure to provide a method of electrolysing hydrogen bromide in a safe manner. It is additionally an object of the present disclosure to provide a method of electrolysing hydrogen bromide which helps to mitigate global warming. It is moreover an object of the present disclosure to provide a method of electrolysing hydrogen bromide which assists in the recovery of bromine. It is also an object of the present disclosure to provide hydrogen which at least partially overcomes the drawbacks encountered in the art. It is also an object of the present disclosure to provide bromine which at least partially overcomes the drawbacks encountered in the art. It is also an object of the present disclosure to provide a use of an aqueous composition in electrolysis of hydrogen bromide which at least partially overcomes the drawbacks encountered in the art.

### SUMMARY

Surprisingly, it has been found that the problem underlying the disclosure is overcome by methods, hydrogen, bromine, and uses according to the claims. Further embodiments of the disclosure are outlined throughout the description.

According to a first aspect, the disclosure provides a method of electrolysing hydrogen bromide comprising the following steps:

i) synthesizing sulfuric acid such that hydrogen bromide is produced,

ii) providing an electrolytic cell comprising an anode, a cathode, and a membrane sandwiched between the anode and the cathode,

iii) feeding a first composition comprising hydrogen bromide and water to the anode,

iv) feeding a second composition comprising hydrogen bromide and water to the cathode, and

v) operating the electrolytic cell to produce hydrogen at the cathode wherein the hydrogen bromide fed in step iii) and/or the hydrogen bromide fed in step iv) is hydrogen bromide produced in step i).

More particularly, the present disclosure relates to a method of electrolysing hydrogen bromide comprising the following steps:
i) synthesizing sulfuric acid such that hydrogen bromide is produced,
ii) providing an electrolytic cell comprising an anode, a cathode, and a membrane sandwiched between the anode and the cathode,
iii) feeding a first composition comprising hydrogen bromide and water to the anode,
iv) feeding a second composition comprising hydrogen bromide and water to the cathode, wherein the hydrogen bromide concentration of the second composition is at least 4 mol/kg, and
v) operating the electrolytic cell to produce hydrogen at the cathode,

wherein the hydrogen bromide produced in step i) is used to prepare the first composition fed in step iii) or both the first composition and the second composition fed in steps iii) and iv).

According to a second aspect, the present disclosure provides a method of electrolysing hydrogen bromide comprising the following steps:
i) providing a stream containing hydrogen bromide obtained from the synthesis of sulfuric acid,
ii) providing an electrolytic cell comprising an anode, a cathode, and a membrane sandwiched between the anode and the cathode, viii) feeding a first composition comprising hydrogen bromide and water to the anode,
iv) feeding a second composition comprising hydrogen bromide and water to the cathode, and
v) operating the electrolytic cell to produce hydrogen at the cathode,

wherein the stream containing hydrogen bromide provided in step i) is used to prepare the first composition fed in step iii) or both the first composition and the second composition fed in steps iii) and iv).

More particularly, the present disclosure provides a method of electrolysing hydrogen bromide comprising the following steps:
i) providing a stream containing hydrogen bromide obtained from the synthesis of sulfuric acid,
ii) providing an electrolytic cell comprising an anode, a cathode, and a membrane sandwiched between the anode and the cathode,
iii) feeding a first composition comprising hydrogen bromide and water to the anode,
iv) feeding a second composition comprising hydrogen bromide and water to the cathode, wherein the hydrogen bromide concentration of the second composition is at least 4 mol/kg, and
v) operating the electrolytic cell to produce hydrogen at the cathode,

wherein the stream containing hydrogen bromide provided in step i) is used to prepare the first composition fed in step iii) or both the first composition and the second composition fed in steps iii) and iv).

Surprisingly, in both the first and the second aspects, it has been found that increasing the HBr concentration at the cathode of the electrolysis cells reduces the operational voltage, which has for consequence to lower the OPEX.

For example, the hydrogen bromide concentration of the second composition is ranging from 4 to 10 mol/kg; preferably from 4 to 9 mol/kg, more preferably from 4 to 8 mol/kg, or from 4.5 to 8 mol/kg, or from 5 to 8 mol/kg.

For example, the electrolytic cell is operated in step v) at an operational voltage Uₒₚ of at most 1900 mV, preferably of at most 1800 mV; more preferably at most 1700 mV; even more preferably of at most 1600 mV, and most preferably of at most 1500 mV.

For example, the electrolytic cell is operated in step v) at an operational voltage (Uₒₚ) from 400 to 1900 mV, preferably from 500 to 1800 mV; more preferably from 600 to 1700 mV; even more preferably from 700 to 1600 mV, and most preferably from 800 to 1500 mV.

For example, the electrolytic cell is operated in step v) at an operational current density Jₒₚ of at least 3 kA/m², preferably at an operational current density Jₒₚ of at least 5 kA/m². preferably of at least 4 kA/m²; more preferably of at least 5 kA/m², even more preferably of at least 6 kA/m²; most preferably of at least 7 kA/m²; even most preferably of at least 8 kA/m²; or of at least 9 kA/m²; or at least 10 kA/m².

For example, the electrolytic cell is operated in step v) at an operational current density (Jₒₚ) of at most 12 kA/m²; preferably of at most 11 kA/m², or of at most 15 kA/m².

For example, the electrolytic cell is operated in step v) at an operational current density (Jₒₚ) ranging from 3 kA/m² to 15 kA/m²; preferably from 4 kA/m² to 12 kA/m² or from 5 kA/m² to 12 kA/m² or from 6 kA/m² to 12 kA/m².

For example, the electrolytic cell is operated in step v) at an operational temperature Tₒₚ of at least 70° C., wherein Tₒₚ is below the boiling point of the second composition, preferably at a temperature of 75° C. or more, more preferably at a temperature of 80° C. or more; even more preferably, at a temperature of 85° C. or more; and most preferably, at a temperature of 90° C. or more.

For example, the electrolytic cell is operated in step (v) at an operational temperature Tₒₚ ranging from 70° C. to 122° C., preferably from 70° C. to 120° C. or less, more preferably from 75° C. to 115° C., even more preferably from 80° C. to 110° C., most preferably from 85° C. to 105° C., even most preferably from 90° C. to 100° C., or from 80° C. to 95° C., or from 75 to 95° C.

For example, the first composition and the second composition are both a liquid composition.

For example, the electrolytic cell is operated at an operational pressure pop which increases from the anode to the cathode.

For example, the electrolytic cell is operated in step v) at least partially at an operational pressure pₒₚ above 0.1 MPa, preferably above 0.15 MPa; more preferably above 0.2 MPa.

For example, the membrane is a fluoropolymer membrane having a glass transition temperature T_{g} of at least 110° C. as determined according to DIN EN ISO 11357-2: 2020-08, preferably of at least 112° C., more preferably of at least 115° C.; even more preferably of at least 118° C.; most preferably of at least 120° C.; even most preferably of at least 122° C.; or of at least than 125° C.

For example, the membrane is a fluoropolymer membrane having a glass transition temperature T_{g} equal to or lower than 170° C. as determined according to DIN EN ISO 11357-2:2020-08; preferably equal to or lower than 168° C.; more preferably equal to or lower than 165° C.; even more preferably equal to or lower than 162° C.; most preferably equal to or lower than 160° C.

For example, the membrane is a fluoropolymer membrane having a glass transition temperature T_{g} in the range of 110° C. to 170° C. as determined according to DIN EN ISO 11357-2:2020-08, or of 120° C. to 165° C.

For example, the membrane is a fluoropolymer membrane comprising —(CF₂—CF₂)— repeat units.

For example, the membrane is a fluoropolymer membrane that does not comprise structural entities of the formula —O—CF₂—CF(CF₃)—O—.

For example, the membrane is a sulfonated fluoropolymer membrane.

For example, the sulfonated fluoropolymer membrane comprises —O—(CF₂)ₙ—SO₃H groups, wherein n is an integer selected from 1, 2, 3, 4, and 5, preferably 2.

For example, the sulfonated fluoropolymer membrane comprises a hydrolysed copolymer of F₂C═CF₂ and CF₂═CF—O—(CF₂)₂—SO₂F.

For example, the membrane is a fluoropolymer membrane that has an acid capacity of equal to or greater than 0.9 meq/g; preferably, equal to or greater than 0.95 meq/g; more preferably, equal to or greater than 1.0 meq/g.

For example, the membrane is a fluoropolymer membrane which has an acid capacity ranging between 0.9 and 1.5 meq/g; preferably between 0.95 and 1.5 meq/g; more preferably between 1.0 and 1.4 meq/g; even more preferably, between 1.0 and 1.3 meq/g; and most preferably between 1.0 and 1.2 meq/g. As used herein, meq/g refers to milli-equivalent per gram, wherein the equivalent is mol —H (i.e., mol of H-acidic sites), preferably mol —SO₃H (i.e., mol of SO₃H-groups).

For example, in step v) bromine is produced at the anode.

For example, the method does not occur in a flow battery.

For example, the method occurs in the absence of hydrogen fluoride, hydrogen chloride, and/or hydrogen iodide.

Preferably, the hydrogen bromide produced in step i) is partly fed to the anode in step iii) and is partly fed to the cathode in step iv).

The concept “OPEX” means “operational expenditures”, and is expressed herein in units of surface power density (W/m²). This is the result of the multiplication of the operational voltage (in mV) of an electrolytic cell by the applied current density (in kA/m²) (Uₒₚ×Jₒₚ).

As used herein, hydrogen bromide which is produced in step i) is a side product of a reaction in which sulfuric acid (H₂SO₄) is synthesized, i.e., a side product of a sulfuric acid synthesis. Such a reaction may also be referred to as synthesis of sulfuric acid (or of H₂SO₄) or simply H₂SO₄ synthesis. FIG. 5 shows preferred routes for producing hydrogen bromide in a sulfuric acid synthesis:

Accordingly, it is preferred that in a method according to the present disclosure, the HBr is coming from an interaction of H₂S, S, or SOₓ (x being in particular 2) with Br₂ and water (H₂O). The following conversion reactions are particularly preferred:

H₂S+4Br₂+4H₂O→H₂SO₄+8HBr

S+3Br₂+4H₂O→H₂SO₄+6HBr

SO₂+Br₂+2H₂O→H₂SO₄+2HBr

As seen above, the HBr is a side product of a sulfuric acid synthesis in step i). When step i) only comprises providing a stream containing hydrogen bromide obtained from the synthesis of sulfuric acid, said stream will comprises traces of sulfur-based compounds such as H₂SO₄, H₂S, S, and/or SOₓ (x being in particular 2). The presence of sulfur-based compounds in the stream containing hydrogen bromide obtained from the synthesis of sulfuric acid can be determined by gas chromatography.

For example, the stream containing hydrogen bromide obtained from the synthesis of sulfuric acid comprises at least 1 ppm by weight based on the total weight of the stream, of at least one selected from H₂SO₄, H₂S, S, SOₓ (x being in particular 2), and any mixture thereof. For example, the stream containing hydrogen bromide obtained from the synthesis of sulfuric acid comprises from 1 ppm by weight to 1 wt. % based on the total weight of the stream, of at least one selected from H₂SO₄, H₂S, S, SOₓ (x being in particular 2), and any mixture thereof; for example, from 5 ppm by weight to 0.5 wt. %; or from 10 ppm by weight to 0.1 wt. %.

One way to look at HBr produced in this way is that HBr is a valuable resource which has a potential for recovering both, bromine and hydrogen. In particular, it is of interest to close the bromine loop and to recycle HBr back into Br₂. This is however typically done by thermal oxidation in which the HBr is simply burned forming Br₂ and water. Such reaction is highly exothermic and thus needs to be carefully controlled. Moreover, the hydrogen contained in the HBr is not recovered but is rather lost. In advantageous contrast, the method according to the present disclosure can be easily controlled and can further allow for a recovery of both, H₂ and Br2. In other words, the method according to the present disclosure can advantageously valorise HBr which is produced as a side product in a sulfuric acid synthesis, i.e., which is produced in an H₂SO₄ synthesis.

Further, FIG. 6 summarizes a typical reaction sequence which yields valuable hydrogen by converting a sulfur(S)-containing and potentially nitrogen(N)-containing feedstream via an oxidation with bromine to give at least H₂SO₄ and HBr and a subsequent electrochemical splitting of HBr (HBr electrolysis) into hydrogen and (not shown) bromine.

FIG. 6 demonstrates that the method according to the present disclosure allows for producing hydrogen from otherwise polluting raw materials like H₂S, S, SOₓ and NOₓ, which hydrogen can play the desired role in mitigating global warming.

As used herein, an electrolytic cell comprises two electrodes, namely the anode and the cathode, between which an electric field can be applied. For this, the anode and the cathode regularly comprise electroconductive material, especially metal, coated metal, carbon cloth, graphite felt, carbon fibre composite, carbon loaded polymer, or graphite, and are preferably made of carbon fibre composite or coated metal. HBr forms a very corrosive environment but the mentioned electroconductive materials can regularly withstand such a corrosive environment and are hence preferred.

As used herein, a membrane is a sheet or layer which can be used in standard electrolysis cells as a proton exchange membrane. Accordingly, protons can migrate through such a membrane.

As used herein, a membrane sandwiched between the anode and the cathode is a membrane having two opposing surfaces, with the anode being provided on one of the two opposing surfaces and the cathode being provided on the other one of the two opposing surfaces.

As used herein, a composition comprising hydrogen bromide and water is an aqueous composition in which HBr is dissolved in water. This is true for the first composition and the second composition. The HBr dissolved in water will regularly be dissociated in the water such that the (first, second) composition will regularly comprise ionic species, especially H⁺, H₃O⁺ and Br⁻. The first and second composition can both be present in a liquid state, or can both be present in a gaseous state. It is also possible that the first composition is present in a liquid state, while the second composition is present in a gaseous state. It is also possible that the second composition is present in a liquid state, while the first composition is present in a gaseous state.

According to step v) of the method according to the present disclosure, the electrolytic cell is operated to produce hydrogen at the cathode. Logically, this requires to apply an electric field between the anode and the cathode. Alternatively, it can be said that an operational voltage has to be applied to the electrolytic cell. It can therefore be said that a method of electrolysing hydrogen bromide according to the present disclosure, which can alternatively be named an electrolysis of hydrogen bromide or HBr electrolysis, refers to an electrolytic split of HBr into hydrogen and a bromine species (Br₂ and/or Br₃⁻) by applying an electric field, or an operational voltage, to the anode and the cathode.

For an electrolysis of HBr, it is required to feed HBr to an anode of an electrolytic cell where protons are generated. The protons then migrate to a cathode, in the present case migrate through the sandwiched membrane to the cathode. According to the present disclosure, it is surprisingly advantageous to feed HBr also to the cathode, i.e., to have a step iv) of feeding a second composition comprising hydrogen bromide and water to the cathode. With such an HBr feed to the cathode, it can be possible to operate the electrolytic cell at a lower operational voltage. A lower operational voltage reduces the

OPEX of the method of electrolysing hydrogen bromide and thus makes the HBr electrolysis more economical. Further with such an HBr feed to the cathode, it can be possible to operate the electrolytic cell at higher temperatures which lowers cooling and/or heating requirements. The lowered cooling/heating requirements also reduce the OPEX of the method of electrolysing hydrogen bromide and thus also make the HBr electrolysis more economical. Additionally, with such an HBr feed to the cathode, it can be possible to operate the electrolytic cell at higher current densities. Higher current densities reduce the CAPEX of the method of electrolysing hydrogen bromide and thus make the HBr electrolysis more economical. Moreover, the method of electrolysing hydrogen bromide according to the present disclosure may produce hydrogen in an eco-friendly manner, thereby assisting in mitigating global warming.

Further, feeding of HBr on the cathode side can reduce the concentration gradient across the membrane and can reduce or even mitigate the undesirable transfer of HBr and/or Br₂ and/or Br⁻ from the anode to the cathode through the membrane. Additionally, the presence of HBr on the cathode side may allow HBr to cross through the membrane from the cathode to the anode side. This results in a global increase in the efficiency of the system and allows avoiding any perturbation during electrolysis. Without wishing to be bound to theory, it is assumed that in the inventive method, there is actually HBr crossing in the reverse direction, i.e., from the cathode to anode. Such an HBr crossing in the reverse direction is considered to be one of the reasons why the efficiency of the inventive method can be increased.

It is preferred that in a method of electrolysing hydrogen bromide according to the present disclosure, the hydrogen bromide concentration of the second composition is ≥0.5 mol/kg, more preferably ≥1 mol/kg, still more preferably ≥2 mol/kg, even more preferably ≥3 mol/kg, further preferably ≥4 mol/kg, even further preferably ≥5 mol/kg, and most preferably ≥6 mol/kg, with mol/kg referring to mol of hydrogen bromide per kilogram of the second composition. All the above-mentioned effects of the second composition comprising hydrogen bromide and water being fed to the cathode can be increasingly more pronounced when the hydrogen bromide concentration of the second composition is increasingly higher, namely when the hydrogen bromide concentration of the second composition is increasing from the preferred concentration of ≥0.5 mol/kg up to the most preferred concentration of ≥6 mol/kg.

Herein, hydrogen bromide concentrations are regularly given in mol/kg, i.e., in mol HBr per kg composition (or solution). HBr has a molecular weight of 80.91 g/mol. Accordingly, the hydrogen bromide concentration (c_{HBr}) of the second composition of for example ≥1 mol/kg can alternatively be expressed as ≥80.91 g/kg, i.e., ≥80.91 g of HBr per kg of composition. The same conversion can be made for any concentration referred to herein.

It is preferred that in a method of electrolysing hydrogen bromide according to the present disclosure, the electrolytic cell is operated in step v) at an operational voltage Uₒₚ≤1900 mV, preferably at an operational voltage Uₒₚ≤1700 mV (but above 0 mV, i.e., Uₒₚ>mV). Operating the electrolytic cell at such an operational voltage can improve the selectivity of the reaction towards HBr electrolysis and hereby reduce the OPEX of the method and can thus make the HBr electrolysis more economical.

It is preferred that in a method of electrolysing hydrogen bromide according to the present disclosure, the electrolytic cell is operated in step v) at an operational temperature Tₒₚ>70° C., wherein Tₒₚ is below the boiling point of the second composition, preferably at an operational temperature 70° C.≤Tₒₚ≤122° C. Operating the electrolytic cell at such an operational temperature can lower cooling and/or heating requirements. In particular, HBr is a side product of many different sulfuric acid syntheses. Such HBr is typically hot and would regularly have to be cooled down for a subsequent electrolysis thereof. Performing the electrolysis at an operational temperature Tₒₚ>70° C. reduces the need for such cooling down.

Additionally, higher temperatures typically increase the proton conductivity of a fluoropolymer-comprising membrane, which can allow operation at higher current densities and/or at lower voltages. Higher current densities help to keep the CAPEX low. In this context, it is preferred that the electrolysis is performed at or above 70° C. (≥70° C.). At such temperatures, liquid-liquid phase separation can be avoided. It is thus particularly preferred that the operational temperature Tₒₚ is maintained at >70° C., more specifically at >90° C., especially at >100° C.

Additionally, operational temperatures of Tₒₚ>70° C., but below the boiling point of the second composition, can decrease a resistance of the membrane which can allow for higher proton conductivities. Higher proton conductivities can allow for higher current densities at lower operational voltages. Higher current densities can help to keep CAPEX low, while lower operational voltages can lead to lower OPEX, thereby making the method of electrolysing hydrogen bromide according to the present disclosure particularly economical. At the same time, a boiling of the second composition can be prevented so that no gaseous HBr is formed, especially no gaseous HBr which might escape to the environment. This can help to run the method of electrolysing hydrogen bromide in a safe manner.

All these effects related to the operational temperature can be even more pronounced when the operational temperature is 70° C.≤Tₒₚ≤122° C.

It is preferred that in a method of electrolysing hydrogen bromide according to the present disclosure, the first composition and the second composition are both a liquid composition. Such a method can also be termed an electrolysis in aqueous phase. With the first composition and the second composition both being liquid a composition, formation of gaseous HBr can be suppressed, so that no such dangerous gaseous HBr can escape to the environment. This can help to run the method of electrolysing hydrogen bromide in a particularly safe manner.

An HBr electrolysis in aqueous phase follows the reaction 2HBr+Br⁻→Br₃⁻+H₂ and has a threshold voltage of 1.10 V. An HBr electrolysis in gas phase follows the reaction 2HBr→Br₂+H₂ and has a threshold voltage of 0.58 V. Considering equal losses during the electrolytic process, it is thereby seen that production of hydrogen from HBr in both aqueous and gas phases will be more energy efficient than current state-of-the-art technology for production of green hydrogen by water electrolysis. Further, while being slightly inferior in terms of threshold voltage and energy demand, HBr electrolysis in an aqueous phase can lead to a safer production of hydrogen and bromine as no dangerous gaseous HBr may escape the overall electrolysis process and can lead to an easier handling of the resulting bromine as this is obtained in a dissolved form.

It is preferred that in a method of electrolysing hydrogen bromide according to the present disclosure, the first composition and the second composition are both a liquid composition which has an operational temperature above 60° C., still more preferably an operational temperature above 70° C. That is, it is preferred that the temperature of the first composition fed to the anode is >60° C. and simultaneously the temperature of the second composition fed to the cathode is >60° C., and it is more preferred that the temperature of the first composition fed to the anode is >70° C. and simultaneously the temperature of the second composition fed to the cathode is >70° C. Br₂ solubility in water is rather limited but this compound is perfectly soluble in HBr in the form of Br₃⁻. As soon as at least 33% of Br is present in the form of HBr, there is just one phase and no inhomogeneity in the electrochemical cell (the electrolytic cell). This is a typical scenario for fuel cells, which are used for energy storage, and for safety reasons it is highly preferable to store the Br₂ in liquid solution as Br₃⁻. However, if the purpose is Br₂ recovery and production of hydrogen, a high conversion level per pass is highly desirable. The conversion level above 67% of HBr per pass without any phase separation and destabilizing of the performance of the electrolytic cell is typically not possible in aqueous phase at low temperatures, in particular not possible below the boiling temperature of Br₂ (58.8° C.). Preferably above 60° C., more preferably above 70° C., Br₂ evaporates sufficiently fast, thereby preventing the formation of a second liquid phase at a high conversion level.

For a preferred electrolysis in aqueous phase, i.e., when feeding the first composition and the second composition both as a liquid composition at above 60° C., more preferably at above 70° C., fluoropolymer membranes having a significantly higher glass transition temperature (T_{g}) are preferred, inter alia from the viewpoint of a sustainable electrolysis. Hence, for such a case it is preferred that the T_{g} of the fluoropolymer membrane is at least 30° C. and more preferably 40° C. higher than the operational temperature of the electrolysis, i.e., the temperature of the first and/or second composition, preferably the temperature of the first and the second composition. Such a temperature setting can lead to a particularly sustainable HBr electrolysis.

It is preferred that in a method of electrolysing hydrogen bromide according to the present disclosure, the electrolytic cell is operated at an operational pressure pop which increases from the anode to the cathode. In other words, there is a pressure gradient that increases from the anode to the cathode, wherein the respective pressures at the anode and the cathode have the same reference point, i.e., are either both absolute pressures, or are both gauge pressures relative to the atmosphere surrounding the electrolytic cell. In such a case, the electrolysis regularly occurs in the gaseous phase, i.e., feeding gaseous streams to the anode and the cathode. The pressure at the cathode is in such a case higher than the pressure at the anode, preferably higher by ≥0.01 MPa (i.e., the difference between the pressure at the cathode and the pressure at the anode is 0.01 or more MPa), more preferably higher by ≥0.02 MPa, still more preferably higher by ≥0.05 MPa, and most preferably higher by ≥0.1 MPa. As an example, when the absolute pressure at the anode is 0.1 MPa, the absolute pressure at the cathode is 0.11 to 0.3 MPa, more preferably 0.12 to 0.25 MPa, still more preferably 0.15 to 0.2 MPa, and most preferably 0.2 MPa. However, optional pressures at the cathode which are higher than the pressure at the anode by 1 MPa, by 2 MPa, by 3 MPa, by 4 MPa, or even by 5 MPa are also contemplated. With such increasing pressures, or pressure gradients, reduced operational voltages of the electrolytic cell can be achieved, which can lead to reduced OPEX. Additionally, the pressure gradient may allow to obtain the H₂ at the cathode side at a higher pressure, so that no or less compression may be required subsequently for densifying the obtained H₂. Additionally, operation at differential pressure (the pressure increases from the anode to the cathode) can improve the operational parameters.

For the case when the anode feed is gas-phase HBr (either with or without a pressure gradient), it is preferred that the second aqueous composition (or feed) sent to the cathode comprises ≤6 mol/kg hydrogen bromide, still more preferred ≤5 mol/kg hydrogen bromide, in particular preferred ≤4 mol/kg hydrogen bromide, more particularly preferred ≤3 mol/kg hydrogen bromide, and most preferred ≤2 mol/kg hydrogen bromide. The beneficial effects on operational voltage may also be brought about when there is the pressure gradient from the anode to the cathode. However, care must be taken due to the risks of membrane damage at higher pressures and simultaneously increased temperatures. Especially at higher temperatures thinner membranes may be prone to break. With the listed reduced HBr concentrations, a balance between the mentioned effects and risks can be achieved.

It is preferred that in a method of electrolysing hydrogen bromide according to the present disclosure, the electrolytic cell is operated in step v) at least partially at an operational pressure pₒₚ>0.1 MPa. With such an increased operational pressure, reduced operational voltages of the electrolytic cell may be achieved, which can lead to reduced OPEX. Additionally, the increased operational pressure may allow obtaining the H₂ at the cathode side at a higher pressure, so that no or less compression may be required subsequently for densifying the obtained H₂.

It is preferred that in a method of electrolysing hydrogen bromide according to the present disclosure, the electrolytic cell is operated in step v) at an operational current density Jₒₚ≥3 kA/m², preferably at an operational current density Jₒₚ≥5 kA/m². With such increased current densities, it can be possible to lower the CAPEX of the method of electrolysing hydrogen bromide, thereby making the method more economical.

It is preferred that in a method of electrolysing hydrogen bromide according to the present disclosure, the membrane is a fluoropolymer membrane having a glass transition temperature T_{g}≥110° C., preferably having a glass transition temperature T_{g}≥120° C., more preferably having a glass transition temperature T_{g}≥125° C. As used herein, a fluoropolymer membrane comprises a fluoropolymer, hence it is termed a fluoropolymer membrane. Preferably, the fluoropolymer membrane (in a dry state) consists of the fluoropolymer, more preferably consists of the fluoropolymer in a chemically stabilized form. As used herein, a fluoropolymer is a fluorocarbon-based polymer with multiple carbon-fluorine bonds. Such a fluoropolymer is regularly free of silicon atoms. Such a fluoropolymer may further be free of chlorine, bromine and/or iodine atoms.

As used herein, the glass transition temperature (or T_{g}), of the fluoropolymer membrane is determined according to DIN EN ISO 11357-2:2020-08 (half-step-height method). Accordingly, as used herein, the glass transition temperature of the fluoropolymer membrane is determined by a differential scanning calorimetry (DSC) measurement, more specifically from a curve obtained by such a DSC measurement. The glass transition temperature of the fluoropolymer membrane is determined on a sample of the fluoropolymer membrane, more specifically on a sample of the fluoropolymer membrane in the fully hydrated state. According to the present disclosure, a fluoropolymer membrane in a fully hydrated state is a fluoropolymer membrane which does not take up any further (deionized) water (deionized H₂O, as described in ASTM D5127-13 (2018) standard) at a temperature of 80° C. after 24 hours, which is hence a fully hydrated fluoropolymer membrane, or a fluoropolymer membrane saturated with water. Hence, the water uptake of the fluoropolymer membrane has reached its maximum. A fully hydrated fluoropolymer membrane is obtained by immersing the fluoropolymer membrane in deionized water which will result in a weight gain of the fluoropolymer membrane as measurable by a balance. When there is no weight gain over time anymore, the fluoropolymer membrane is in the fully hydrated state. A fluoropolymer membrane in the fully hydrated state is regularly obtained by immersing the fluoropolymer membrane in deionized water having a temperature of 80° C. for a time period of 24 hours.

In some reports, glass transition temperatures of dried membranes are reported (for example in Jung et al., Int. J. Hydrogen Energy 37, 12580-12585, 2012). However, in such a dry state, the membranes show only poor conductivity. During the hydration of the membrane, the T_{g} of the membrane typically decreases drastically because of the plasticizer effect of water. According to the present disclosure the T_{g} of the fluoropolymer membrane in the fully hydrated state is relied on because this T_{g} of the fully hydrated state reflects best the behaviour of a membrane during an electrolysis, in particular during an electrolysis of hydrogen bromide.

Apart from the glass transition temperature (T_{g}), other characteristics of the fluoropolymer membrane reported herein refer to the fluoropolymer membrane in a dry state.

As used herein, the glass transition temperature (T_{g}) refers to the lowest glass transition temperature of the fluoropolymer. It is known that certain polymers or membranes made of polymers, respectively, e.g., Nafion®-type membranes, may have several glass transition temperatures, in particular two glass transition temperatures. The first glass transition temperature is due to the mobility of the main chain in the polymer matrix, while the second glass transition temperature is due to side chain effects, especially effects associated with strong interactions of functional groups in such side chains like sulfonic acid groups. Once the first glass transition temperature has been reached, the membrane undergoes irreversible changes and can in particular not be used for an electrolysis process anymore. Accordingly, in the context of the present disclosure, if a material, especially a membrane or membrane sample, exhibits several glass transition temperatures, only the lowest T_{g} is relevant for the T_{g} definitions provided herein.

A fluoropolymer membrane having a glass transition temperature T_{g}≥110° C. can allow for carrying out the method of electrolysing hydrogen bromide according to the present disclosure at higher temperatures and/or at higher pressures, because of a more resilient fluoropolymer membrane. Without wishing to be bound to theory, it is assumed that the resilience to HBr and, after electrolysis, H₂ and Br₂ at higher temperatures and also at higher pressures is imparted by the fluoropolymer membrane having a glass transition temperature of equal to or higher than 110° C. (T_{g}≥110° C.). Further, especially higher temperatures can decrease the resistance of the fluoropolymer membrane which can allow for higher proton conductivities. Higher proton conductivities can allow for higher current densities at lower operational voltages. Higher current densities can help to keep CAPEX low, while lower operational voltages lead to lower operational expenditures (OPEX), thereby making the method according to the present disclosure particularly economical. Such a method according to the present disclosure may also produce hydrogen in an eco-friendly manner, thereby assisting in mitigating global warming. These effects can be even more pronounced when using a fluoropolymer membrane having T_{g}≥120° C. and still more pronounced when using a fluoropolymer membrane having T_{g}≥125° C.

It is preferred that the fluoropolymer membrane has a glass transition temperature T_{g} in the range of 110 to 170° C., more preferred of 120 to 170° C. and still more preferred of 125 to 170° C. As discussed herein, HBr is a side product of many different sulfuric acid syntheses. Such HBr is typically hot and would regularly have to be cooled down for a subsequent electrolysis thereof. Performing the electrolysis at increased temperatures reduces the need for such cooling down. Additionally, higher temperatures typically increase the proton conductivity of a fluoropolymer membrane, which can allow operation at higher current densities and/or at lower voltages. Higher current densities help to keep the CAPEX low. In this context, it is preferred that the HBr electrolysis is performed above 70° C. At such temperatures, liquid-liquid phase separation can be avoided. When the fluoropolymer membrane has a glass transition temperature T_{g} in the range of 110 to 170° C., more preferred in the range of 120 to 170° C. and still more preferred in the range of 125 to 170° C. the operational temperature of the HBr electrolysis may be maintained at >70° C., more specifically at >90° C., especially at >100° C., which can lead to the advantages of higher operational temperatures discussed herein.

It is preferred that the fluoropolymer membrane, more specifically the fluoropolymer comprised by and preferably constituting the membrane, comprises —(CF₂—CF₂)— repeat units. Such —(CF₂—CF₂)— repeat units may increase the resilience of the fluoropolymer membrane. An increased resilience can allow for HBr electrolysis at higher temperatures and at higher pressures, with may allow operation at higher current densities and/or at lower voltages, thereby making the method according to the present disclosure more economical.

It is preferred that the fluoropolymer membrane, more specifically the fluoropolymer comprised by and preferably constituting the membrane, does not comprise structural entities of the formula —O—CF₂—CF(CF₃)—O—. Such structural entities are present in commercial membranes sold under the tradename Nafion®, but may lead to less rigidity of the membrane which is thus more prone to degradation at higher temperatures and higher pressures. Such membranes are therefore disfavoured for the method according to the present disclosure.

It is preferred that the fluoropolymer membrane, more specifically the fluoropolymer comprised by and preferably constituting the membrane, comprises —CF₃ chain ends. Such —CF₃ chain ends may increase the resilience of the fluoropolymer membrane. An increased resilience can allow for HBr electrolysis at higher temperatures and at higher pressures, with may allow operation at higher current densities and/or at lower voltages, thereby making the method according to the present disclosure more economical.

It is preferred that the fluoropolymer membrane is a sulfonated fluoropolymer membrane. More specifically, the fluoropolymer comprised by and preferably constituting the membrane is a sulfonated fluoropolymer. As used herein, sulfonated means that the fluoropolymer of the fluoropolymer membrane bears —SO₃H groups. Such —SO₃H groups can increase the proton conductivity of the fluoropolymer membrane, which can allow operation at higher current densities and/or at lower voltages, thereby making the method according to the present disclosure more economical.

It is preferred that the sulfonated fluoropolymer membrane, more specifically the fluoropolymer comprised by and preferably constituting the membrane, comprises —O—(CF₂)ₙ—SO₃H groups, wherein n is an integer selected from 1, 2, 3, 4, and 5, preferably 2. Such —O—(CF₂)ₙ—SO₃H groups can help to achieve an increased proton conductivity of the fluoropolymer membrane while simultaneously increasing the resilience of the fluoropolymer membrane. An advantageous balance between these effects can in particular be obtained when n is selected from 1 to 5 and especially when n is 2. Without wishing to be bound to theory, it is assumed that the comparably short chain length of the —O—(CF₂)ₙ—SO₃H groups increases the glass transition temperature of the fluoropolymer membrane making it more resilient at higher temperatures. As such, the sulfonated fluoropolymer membrane is particularly advantageous from the viewpoint of HBr electrolysis at higher temperatures and/or at higher pressures, and hence at higher current densities and/or at lower voltages. As such, the sulfonated fluoropolymer membrane can make the method according to the present disclosure particularly economical.

It is preferred that the sulfonated fluoropolymer membrane comprises a hydrolysed copolymer of F₂C═CF₂ and CF₂═CF—O—(CF₂)₂—SO₂F. Such a hydrolysed copolymer can lead to an increased proton conductivity and/or an increased resilience of the fluoropolymer membrane. As such, the sulfonated fluoropolymer membrane is particularly advantageous from the viewpoint of HBr electrolysis at higher temperatures and/or at higher pressures, and hence at higher current densities and/or at lower voltages. As such, the sulfonated fluoropolymer membrane can make the method according to the present disclosure particularly economical.

It is preferred that the fluoropolymer membrane has an acid capacity of ≥0.9 meq/g, more preferred between 0.95 and 1.5 meq/g, and particularly preferred between 1.0 and 1.2 meq/g. As used herein, meq/g refers to milli-equivalent per gram, wherein the equivalent is mol —H (i.e., mol of H-acidic cites), preferably mol —SO₃H (i.e., mol of SO₃H-groups). The acid capacity represents the total of active sites or functional groups responsible for proton exchange of the fluoropolymer membrane. Such an acid capacity can increase the proton conductivity and can thereby lead to an increased HBr conversion in the HBr electrolysis. An increased HBr conversion may reduce any need for separation and possible recirculation of unconverted HBr, which can help to maintain the low CAPEX of the method according to the present disclosure.

It is preferred that the fluoropolymer membrane (in dry state) has a density of ≥1.70 g/cm³, more preferred of ≥1.80 g/cm³, still more preferred of ≥1.80 to ≤2.00 g/cm³ and particularly preferred of ≥1.90 to ≤1.95 g/cm³. The density of the fluoropolymer membrane can in particular be determined on a sample thereof according to ASTM D792-20. Such densities may increase the resilience of the fluoropolymer membrane. An increased resilience can allow for HBr electrolysis at higher temperatures and at higher pressures, which may allow operation at higher current densities and/or at lower voltages, thereby making the method according to the present disclosure more economical.

It is preferred that the fluoropolymer membrane (in dry state) has a thickness of 25 to 350 μm, more preferred of 40 to 150 μm, still more preferred of 45 to 130 μm and particularly preferred of 45 to 55 μm. Such a thickness can achieve a balance between sufficient resilience on the one hand and CAPEX on the other hand. At a lower thickness, there is a risk of undesired crossover of hydrogen/bromine through the fluoropolymer membrane. At a higher thickness, an undesirable decrease in proton conductivity may result.

It is preferred that the fluoropolymer membrane (in dry state) has a tensile modulus of 100 to 500 MPa, more preferred of 150 to 400 MPa, still more preferred of 200 to 300 MPa and particularly preferred of 260 to 280 MPa. The tensile modulus of the fluoropolymer membrane can in particular be determined on a sample thereof according to ASTM D638-14. Such a tensile modulus may increase the resilience of the fluoropolymer membrane. An increased resilience can allow for HBr electrolysis at higher temperatures and at higher pressures, which may allow operation at higher current densities and/or at lower voltages, thereby making the method according to the present disclosure more economical.

It is preferred that the fluoropolymer membrane (in dry state) has a tensile stress at break in the machine direction (MD), according to ASTM D882-18, of 10 to 70 MPa, more preferred of 20 to 60 MPa, still more preferred of 30 to 50 MPa and particularly preferred of 35 to 45 MPa. Such a tensile stress at break in MD may increase the resilience of the fluoropolymer membrane. An increased resilience can allow for HBr electrolysis at higher temperatures and at higher pressures, which may allow operation at higher current densities and/or at lower voltages, thereby making the method according to the present disclosure more economical.

It is preferred that the fluoropolymer membrane (in dry state) has a tensile stress at break in the cross direction (CD), according to ASTM D882-18, of 5 to 60 MPa, more preferred of 10 to 50 MPa, still more preferred of 20 to 40 MPa and particularly preferred of 25 to 35 MPa. Such a tensile stress at break in CD may increase the resilience of the fluoropolymer membrane. An increased resilience can allow for HBr electrolysis at higher temperatures and at higher pressures, which may allow operation at higher current densities and/or at lower voltages, thereby making the method according to the present disclosure more economical.

It is preferred that the fluoropolymer membrane (in dry state) has an elongation at break in machine direction (MD), according to ASTM D882-18, of 100 to 200%, more preferred of 120 to 180%, still more preferred of 140 to 160% and particularly preferred of 145 to 155%. Such an elongation at break in MD may increase the resilience of the fluoropolymer membrane. An increased resilience can allow for HBr electrolysis at higher temperatures and at higher pressures, which may allow operation at higher current densities and/or at lower voltages, thereby making the method according to the present disclosure more economical.

It is preferred that the fluoropolymer membrane (in dry state) has an elongation at break in the cross direction (CD), according to ASTM D882-18, of 100 to 350%, more preferred of 120 to 300%, still more preferred of 150 to 250% and particularly preferred of 190 to 210%. Such an elongation at break in CD may increase the resilience of the fluoropolymer membrane. An increased resilience can allow for HBr electrolysis at higher temperatures and at higher pressures, which may allow operation at higher current densities and/or at lower voltages, thereby making the method according to the present disclosure more economical.

It is preferred that in a method of electrolysing hydrogen bromide according to the present disclosure, nitrogen oxide (NOₓ) is converted into nitric acid (HNO₃) and/or ammonia (NH₃) is converted into nitrogen (N₂) in step i). As used herein, “converted” means that step i) includes a reaction in which nitrogen oxide and/or ammonia are raw materials, whereas nitric acid and/or nitrogen are products. This includes that additional raw products participate in the respective reaction, and/or that additional products are formed in the respective reaction

When the sulfuric acid is synthesized in step i) from sulfur oxide (SOₓ), the sulfur oxide may be accompanied by nitrogen oxide, for example nitrogen dioxide (NO₂). This can in particular be the case when the sulfur oxide stems from a flue gas. In such a case, the nitrogen oxide can be converted during the sulfuric acid synthesis in step i). In this way, nitric acid may be additionally produced in step i), for example according to the following reaction: NO₂+H₂O+Br₂→HNO₃+HBr. Advantageously, the nitrogen oxide and in particular nitrogen dioxide, which is part of the otherwise lost flue gas, can thereby be valorised as it is transferred into more valuable compounds including nitric acid which can subsequently be used in other chemical processes.

When the sulfuric acid is synthesized in step i) from hydrogen sulphide (H₂S), the hydrogen sulphide may be accompanied by ammonia. In such a case, the ammonia can be converted during the sulfuric acid synthesis in step i). Especially, nitrogen may be additionally produced in step i), for example according to the following reaction: 2NH₃+3Br₂→N₂+6HBr. The conversion of ammonia into nitrogen can lead to an advantageous ammonia abatement.

It is preferred that in a method of electrolysing hydrogen bromide according to the present disclosure, bromine is produced at the anode in step v). As afore-said, HBr is a typical side product of the chemical industry, especially a typical side product of an H₂SO₄ synthesis, which HBr is thereafter often subjected to thermal oxidation. That is, the HBr is burned to yield Br₂ and H₂O in a highly exothermic reaction requiring careful control, while H₂ is lost. In advantageous contrast, the method of electrolysing hydrogen bromide according to the present disclosure can be easily controlled and can further allow for a recovery of both, H₂ and Br₂.

It is preferred that a method of electrolysing hydrogen bromide according to the present disclosure does not occur in a flow battery. The advantages brought about by the inventive method will regularly not be observed when the method occurs, or is carried out, in a flow battery.

It is preferred that a method according to the present disclosure occurs, or is carried out, in the absence of hydrogen fluoride, hydrogen chloride and/or hydrogen iodide. With hydrogen fluoride, hydrogen chloride and/or hydrogen iodide being absent, the purity of the produced H₂ and/or Br₂ can be improved. Further, fluctuations of the operational voltage can be avoided, which may reduce any need for regulating the HBr electrolysis.

Subject of the disclosure is also hydrogen obtained by a method as described herein. The preferred embodiments of the method described herein including the claims are likewise preferred for this inventive hydrogen in an analogous manner. In this way, advantageously pure hydrogen can be accessible through HBr electrolysis. Further, hydrogen useful for example for fuel synthesis can be accessible through HBr electrolysis which can thereby assist in mitigating global warming.

Subject of the disclosure is also bromine obtained by a method as described herein. The preferred embodiments of the method described herein including the claims are likewise preferred for this inventive bromine in an analogous manner. In this way, advantageously pure bromine can be accessible through HBr electrolysis. Further, bromine useful in subsequent chemical synthesis can be accessible through HBr electrolysis which can thereby assist in closing the bromine loop.

Subject of the disclosure is also a use of an aqueous composition comprising hydrogen bromide as a cathode feed in an electrolysis of hydrogen bromide, wherein the hydrogen bromide stems from a sulfuric acid synthesis. The preferred embodiments of the method described herein including the claims are likewise preferred for this inventive use in an analogous manner. It is in particular preferred that in a use of an aqueous composition comprising hydrogen bromide according to the present disclosure, the hydrogen bromide concentration of the aqueous composition is ≥0.5 mol/kg, more preferably ≥1 mol/kg, still more preferably ≥2 mol/kg, even more preferably ≥3 mol/kg, further preferably ≥4 mol/kg, even further preferably ≥5 mol/kg, and most preferably ≥6 mol/kg, with mol/kg referring to mol of hydrogen bromide per kilogram of the second composition. The advantageous effects of such hydrogen bromine concentrations are the same as discussed herein for the method according to the present disclosure.

### BRIEF DESCRIPTION OF THE DRAWINGS

FIG. 1 shows the general outline of an electrolytic cell which is applicable for a method according to the present disclosure.

FIG. 2 shows the results of HBr electrolyses feeding different HBr concentrations.

FIG. 3 shows the results of further HBr electrolyses feeding different HBr concentrations.

FIG. 4 shows the results of HBr electrolyses in the gas phase.

FIG. 5 is a scheme with different routes for producing hydrogen bromide in a sulfuric acid synthesis.

FIG. 6 is a scheme with a typical reaction sequence yielding valuable hydrogen by converting a sulfur(S)-containing and potentially nitrogen (N)-containing feedstream via oxidation with bromine.

### EXPERIMENTAL SECTION

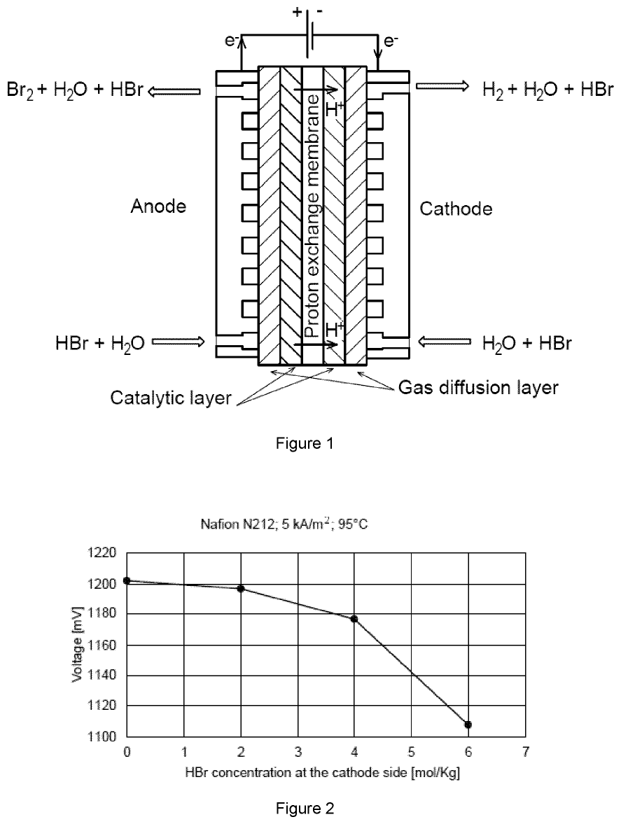

FIG. 1 is a general outline of an exemplary electrolytic cell and an exemplary electrolysis procedure, respectively, which illustrate how a method of electrolysing hydrogen bromide according to the present disclosure can be implemented. The proton exchange membrane depicted in FIG. 1 is for example a fully hydrated fluoropolymer membrane having a glass transition temperature T_{g}≥110° C., for example a fully hydrated Aquivion® E98-05S membrane or a fully hydrated Aquivion® E87-05S membrane. The membrane is sandwiched between two catalytic layers. The catalytic layers themselves are sandwiched between two gas diffusion layers. On the left-hand side, an anode is arranged on a first gas diffusion layer, namely on the surface opposite to the surface on which a first catalytic layer is arranged. On the right-hand side, a cathode is arranged on a second gas diffusion layer, namely on the surface opposite to the surface on which a second catalytic layer is arranged. A first mixture comprising HBr and H₂O is fed to the anode, while a second mixture also comprising HBr and H₂O is fed to the cathode. The HBr fed to the anode as well as the HBr fed to the cathode stems from a synthesis of H₂SO₄ according to SO₂+Br₂+2H₂O→H₂SO₄+2HBr. An electric field is applied to the electrolysis cell such that electrons (e⁻) are transferred from the anode to the cathode. At the anode, HBr migrates through the anode gas diffusion layer to the anode catalytic layer where it is electrooxidized so that Br₂ is formed and protons are remaining. The protons migrate from the anode catalytic layer through the membrane to the cathode catalytic layer. At the cathode catalytic layer, the protons recombine with electrons to H₂. Formed H₂ migrates through cathode gas diffusion layer. As electrolysis products, a stream comprising Br₂ and H₂O is withdrawn from the anode, and a stream comprising H₂, H₂O and HBr is withdrawn from the cathode. The stream withdrawn from the anode may additionally comprise unconverted HBr.

FIG. 2 shows the results of actual electrolyses of HBr feeding different HBr concentrations to the cathode of the used electrolytic cell. The electrolysis was performed under a constant current density of 5 kA/m² and at a constant temperature of 95° C. using a commercial proton exchange membrane (Nafion® N212). It is seen that an increase of the HBr concentrations from 0 mol/kg (deionized water) to 6 mol/kg led to a constantly lower operational voltage. In particular, already at an HBr concentration of 1 mol/kg fed to the cathode, a practically relevant reduction of the operational voltage can be inferred from the experimental results. Significant further reductions of the operational voltage are achieved when an HBr concentration of 2 mol/kg, better of 3 mol/kg, even better of 4 mol/kg, still better of 5 mol/kg, and particularly better of 6 mol/kg is fed to the cathode. It is thus seen that although feeding HBr to the cathode is not at all required for HBr electrolysis, the operational voltage is significantly lowered when HBr is fed to the cathode of the electrolytic cell in which the HBr electrolysis occurs. The lowered operational voltage in turn led to advantageously lowered OPEX.

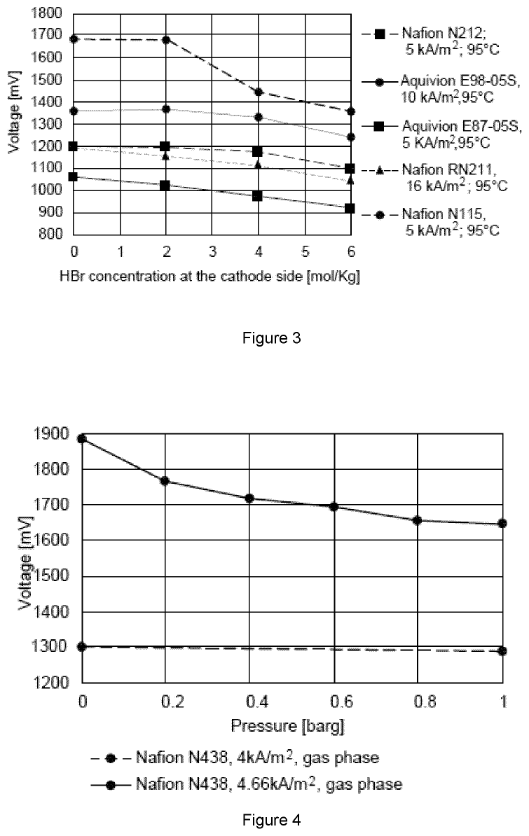

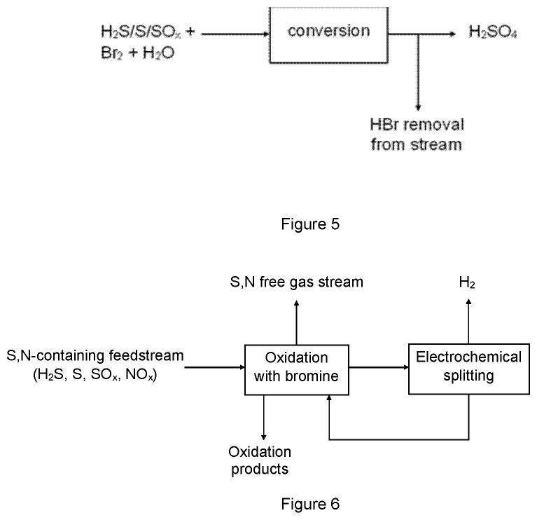

FIG. 3 shows the results of actual electrolyses of HBr using different current densities and different membranes. The results of the experiment reported in FIG. 2 are included again.

Also in these experiments, the HBr concentration of an aqueous HBr solution fed to the cathode of the electrolysis cell was increased from 0 mol/kg (deionized water) over 2 mol/kg and further 4 mol/kg up to 6 mol/kg. It is seen that successful electrolyses were performed at an elevated temperature of 95° C. and at high current densities of 5 kA/m² up to 16 kA/m². It is additionally seen that for various membranes and current densities, with the exception of a minor outlier at 2 mol/kg for the Aquivion® E98-05S membrane, increasing the HBr concentration surprisingly led to a significant lowering of the operational voltage which in turn led to advantageously lowered OPEX.

FIG. 4 shows the results of actual electrolyses of HBr in the gas phase using the same commercial proton exchange membrane (Nafion® N438) at increased pressures at the cathode side. The differential pressure between the anode and the cathode was raised from 0 over 0.2, 0.4, 0.6, and 0.8 to 1 barg (bar gauge; corresponding to pressure differences of 0, 20, 40, 60, 80, and 100 kPa). It is seen that an increase in current density from 4 (two data points) to 4.66 kA/m² (six data points), which has a positive influence on CAPEX, comes at the expense of an increased operational voltage, which has a negative influence on OPEX. It is further seen that increasing the pressure difference between the anode and cathode leads to advantageously lowered operational voltages again. The applied pressure difference thus allows balancing between the undesired OPEX effects of higher operational voltages and the advantageous CAPEX effects of increased operational current densities.

1. A method of electrolysing hydrogen bromide comprising the following steps:
i) synthesizing sulfuric acid such that hydrogen bromide is produced,
ii) providing an electrolytic cell comprising an anode, a cathode, and a membrane sandwiched between the anode and the cathode,
iii) feeding a first composition comprising hydrogen bromide and water to the anode,
iv) feeding a second composition comprising hydrogen bromide and water to the cathode, wherein the hydrogen bromide concentration of the second composition is at least 4 mol/kg, and
v) operating the electrolytic cell to produce hydrogen at the cathode,
wherein the hydrogen bromide produced in step i) is used to prepare the first composition fed in step iii) or both the first composition and the second composition fed in steps iii) and iv).

2. A method of electrolysing hydrogen bromide comprising the following steps:
(i) providing a stream containing hydrogen bromide obtained from the synthesis of sulfuric acid,
ii) providing an electrolytic cell comprising an anode, a cathode, and a membrane sandwiched between the anode and the cathode,
iii) feeding a first composition comprising hydrogen bromide and water to the anode,
iv) feeding a second composition comprising hydrogen bromide and water to the cathode, wherein the hydrogen bromide concentration of the second composition is at least 4 mol/kg, and
v) operating the electrolytic cell to produce hydrogen at the cathode,
wherein the stream containing hydrogen bromide provided in step i) is used to prepare the first composition fed in step iii) or both the first composition and the second composition fed in steps iii) and iv).

3. The method according to claim 1, wherein the hydrogen bromide concentration of the second composition is ranging from 4 to 10 mol/kg; preferably from 4 to 8 mol/kg.

4. The method according to claim 1, wherein the electrolytic cell is operated in step v) at an operational voltage Uₒₚ of at most 1900 mV, preferably at an operational voltage Uₒₚ of at most 1700 mV.

5. The method according to claim 1, wherein the electrolytic cell is operated in step v) at an operational temperature Tₒₚ of at least 70° C., wherein Tₒₚ is below the boiling point of the second composition, preferably at an operational temperature Tₒₚ ranging from 70° C. to 122° C.

6. The method according to claim 1, wherein the first composition and the second composition are both a liquid composition.

7. The method according to claim 1, wherein the electrolytic cell is operated at an operational pressure pₒₚ which increases from the anode to the cathode.

8. The method according to claim 1, wherein the electrolytic cell is operated in step v) at least partially at an operational pressure pₒₚ above 0.1 MPa.

9. The method according to claim 1, wherein the electrolytic cell is operated in step v) at an operational current density Jₒₚ of at least 3 kA/m², preferably at an operational current density Jₒₚ of at least 5 kA/m².

10. The method according to claim 1, wherein the membrane is a fluoropolymer membrane having a glass transition temperature T_{g} of at least 110° C. as determined according to DIN EN ISO 11357-2: 2020-08, preferably having a glass transition temperature T_{g} of at least 120° C.

11. The method according to claim 1, wherein in step i) nitrogen oxide is converted into nitric acid and/or ammonia is converted into nitrogen.

12. The method according to claim 1, wherein in step v) bromine is produced at the anode.

13. The method according to claim 1, which does not occur in a flow battery.

14. The method according to claim 1, which occurs in the absence of hydrogen fluoride, hydrogen chloride, and/or hydrogen iodide.

15. The method according to claim 1 is characterized in that the membrane is a fluoropolymer membrane comprising —(CF₂—CF₂)— repeat units.

16. The method according to claim 1 is characterized in that the membrane is a sulfonated fluoropolymer membrane.
